(19) United States
(12) Patent Application Publication
(10) Pub. No.: US 2008/0263094 A1
(43) Pub. Date: Oct. 23, 2008

(54) MULTI-RENDERED MULTIMEDIA SITE GENERATION APPARATUS, SYSTEMS, AND METHODS

(76) Inventors: Joshua Bass, Carlsbad, CA (US); Adam Newcomb, Vista, CA (US); David Zimet, San Diego, CA (US); Dong Chen, La Jolla, CA (US); Jonathan McKinney, San Diego, CA (US)

Correspondence Address: SCHWEGMAN, LUNDBERG & WOESSNER, P.A., P.O. BOX 2938, MINNEAPOLIS, MN, 55402, US

(21) Appl. No.: 11/738,245

(22) Filed: Apr. 20, 2007

(51) Int. Cl. G06F 17/30

(52) U.S. Cl. 707/104.1

(57) ABSTRACT

Apparatus, systems, and methods disclosed herein may download one or more sets of presentation rendering property values (PRPVs) to a client processing device. Each set of PRPVs may be associated with a set of presentation characteristics of a sensory output device (SOD) used to present a multimedia presentation, a state of the SOD, or a state of a filter used to filter the presentation. A subset of PRPVs may be associated with a presentation element. A presentation page containing the presentation element may be assembled at a multi-rendered presentation server from a template, a set of controls, a view, and a dataset. The page may be assembled such that the set of PRPVs, acting upon the presentation element at the client processing device, is capable of rendering the presentation element for presentation at the SOD with a predetermined set of perceptual characteristics compatible with SOD presentation characteristics.

### TECHNICAL FIELD

Various embodiments described herein relate to apparatus, systems, and methods associated with multimedia processing and presentation, including multi-sensory presentation element rendering.

### BACKGROUND INFORMATION

Currently, an instance of digital multimedia content may be created and encoded specifically for an output device anticipated by the content producer. For example, much Internet browser content is currently created for standard 4×3 aspect ratio computer monitor screens. Annoying black-bar margins may appear on the right and left-hand sides of the 4×3 content window when the standard Internet browser content is displayed on a 16×9 or similar wide-screen computer monitor or home theatre system. Likewise, 16×9 content may display on a 4×3 monitor with horizontal black bands at the top and bottom of the image. Or, if expanded vertically to fill the 4×3 screen, 16×9 content may be cut off on the left and right-hand sides.

In another example, the multimedia content may be encoded with a color palette suitable for a flat screen display, to include pure blacks and pure whites. This encodation may be unsuitable for a National Television Systems Committee (NTSC)-limited monitor, and may even cause damage by exceeding raster power specifications.

### BRIEF DESCRIPTION OF THE DRAWINGS

FIG. 1 is a user interface diagram of a prior art standard 4×3 aspect ratio presentation page showing various presentation elements.

FIG. 2 is a user interface diagram of a prior art standard 4×3 aspect ratio presentation page as displayed on a 16×9 monitor.

FIG. 3 is a user interface diagram of a 4×3 presentation page as adapted by various example embodiments of the invention.

FIG. 4 is a block diagram of an apparatus and a system according to various example embodiments of the invention.

FIG. 5 is a presentation page abstracted according to various example embodiments of the invention.

FIGS. 6A and 6B are flow diagrams illustrating several methods according to various example embodiments of the invention.

FIG. 7 is a block diagram of a computer readable medium (CRM) according to various embodiments.

### DETAILED DESCRIPTION

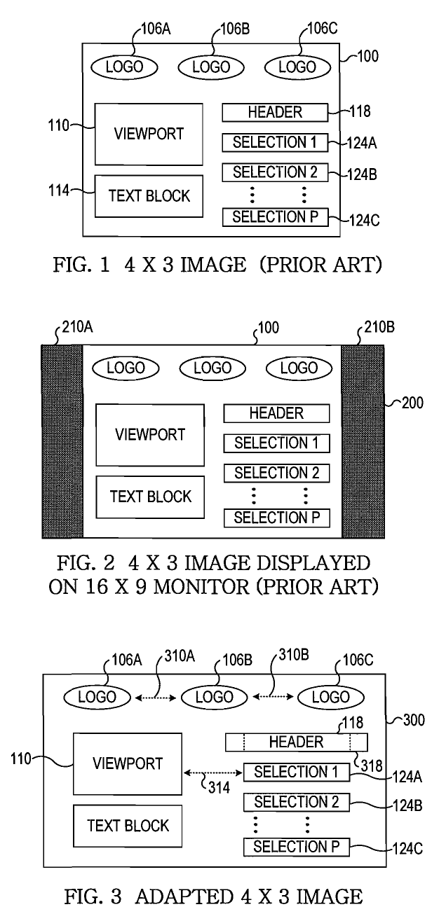

FIG. 1 is a user interface diagram of a prior art standard 4×3 aspect ratio (AR) presentation page 100 showing various presentation elements of a multimedia presentation. “Multimedia presentation” as used herein means any presentation material capable of perception by a human sensory system, including visual, aural, tactile, olfactory, taste, or balance perception. The presentation elements may include one or more logos 106A, 106B, and 106C. The viewport 110 may frame a still image or a video sequence. Other elements may include a viewport 110, text block 114, text header element 118, and selection pushbuttons 124A, 124B, and 124C. The view port 110 may frame a still image or a video sequence. The aforesaid presentation elements are merely examples. Other presentation elements may include radio buttons, sliders, bitmapped images, whether visually or tactilely perceived, a text entry control, a drag-and-drop control, text-fillable fields, and others known to those skilled in the art. Additional presentation elements may include non-traditional material capable of tactile perception, olfactory perception, perception by taste, or perception as a balance sensation.

Some elements may be passive and may not be subject to interaction with a user. Other elements may be active in that their appearance may change when clicked on, mouse hovered over, or otherwise chosen or indicated by the user. An active presentation element may also cause a programmatic state change in an application associated with the presentation, on a presented page, or in a sequence of presented pages. A presentation element may be located within a specified zone of a specified page of a multimedia presentation. “Page” as used herein means a subdivision or segment of the multimedia presentation generally.

FIG. 2 is a user interface diagram of the prior art standard 4×3 AR presentation page 100 as displayed on a 16×9 AR monitor 200. To the annoyance of a viewer or audience of viewers, vertical black or white bands 210A and 210B may appear on the right and left-hand sides of the 16×9 AR monitor 200. The presentation page 100 may thus appear compressed and the 16×9 AR monitor 200 may appear underutilized. Some viewers may apply a “full screen” viewing function to the presentation page 100 to fill the bands 210A and 210B, resulting in cutoff portions of the top and bottom of the presentation page 100.

Embodiments herein may generate a multimedia presentation that is adaptable to capabilities and states of output devices and presentation software on-the-fly as the presentation is presented at a client processing device. Multiple sets of presentation rendering property values (PRPVs) may be generated for downloading to the client processing device for use in the adaptation process. A PRPV is an attribute capable of application to a presentation element to cause a predetermined perceptual characteristic to manifest itself when the element is presented to an audience of one or more people.

A set of PRPVs may be created and maintained for each of several output devices used to present the multimedia presentation. A subset of PRPVs may be associated with each presentation element. In a simple example, a 4×3 AR set of PRPVs may be used by the client processing device to render the presentation page 100. So rendered, the 4×3 AR presentation page 100 may appear on the 16×9 AR monitor 200 as shown in FIG. 2.

FIG. 3 is an interface diagram of a 4×3 presentation page 300 as adapted by various example embodiments of the invention. A 16×9 AR set of PRPVs may be created to render the presentation page 100 as the adapted presentation page 300. PRPVs associated with the logos 106A and 106C may, for example, establish relative locations of these two logos with respect to the logo 106B. 16×9 AR distancing PRPVs may declare larger values for relative separation distances between the logos 106A, 106C and the logo 106B than corresponding distancing PRPVs in a 4×3 AR PRPV set. Using the 16×9 set of PRPVs, the logos 106A and 106C may thus be rendered further distant from the logo 106B than with the 4×3 PRPV set, as shown by distances 310A and 310B of FIG. 3. A distance 314 between the viewport 110 and selection pushbuttons 124A, 124B, and 124C may likewise be set to a larger value when invoking the 16×9 AR PRPV set. Other presentation element attributes may be included in a PRPV set created for a presentation element. For example, an attribute for a width of the header 118 may be set to a larger value in the 16×9 AR version of the header PRPV set than in the 4×3 AR version. An elongation 318 of the header 118 may be rendered as a result.

In another example, some embodiments herein may create a non-NTSC instance of a PRPV for a white logo on a Web page for association with a flat-screen monitor. The non-NTSC instance of the PRPV may associate a pure white color of maximum intensity with the logo. An NTSC instance of the PRPV may be created for use with a cathode ray tube (CRT) version of the white logo. The NTSC instance of the PRPV may associate an off-white color of reduced intensity with the logo. A client processing device may read operating system-supplied display attribute values to determine whether an attached display is NTSC-limited. If a display is determined to be so limited, the example logo may be presented using the NTSC instance of the white logo PRPV. Embodiments herein may thus create subsets of PRPV attributes specific to individual presentation elements as appropriate for particular hardware and presentation software capabilities and states.

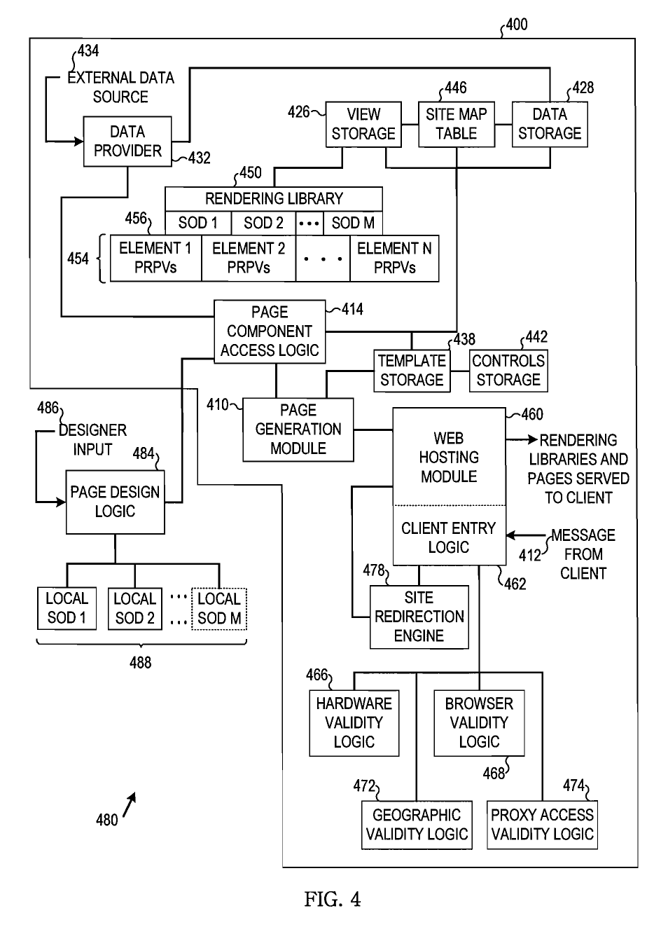

FIG. 4 is a block diagram of an apparatus 400 and a system 480 according to various example embodiments of the invention. The apparatus 400 may be incorporated into a multimedia content server to generate a multimedia presentation that is adaptable to capabilities and states of output devices and presentation software on-the-fly as the presentation is presented at a client processing device.

The apparatus 400 may include a page generation module 410. The page generation module 410 may parse a message 412 received from the client processing device to determine a client domain and a client request. In some embodiments, the message 412 may comprise a uniform resource locator (URL). The page generation module 410 may assemble a template, a view, and a dataset to generate a presentation page in response to the client request.

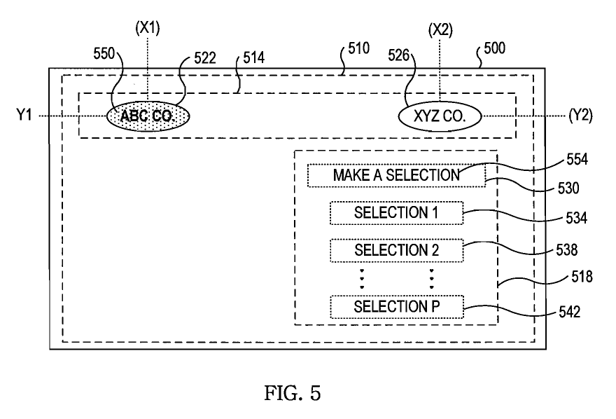

FIG. 5 is a presentation page 500 abstracted according to various example embodiments of the invention. The presentation page 500 may comprise a template 510. “Template,” as used herein is a presentation page abstraction level comprising a set of controls, a set of interactions between controls, and a set of control containment attributes. A “control” as used herein means an object representing an operation to be performed during a time of presenting a presentation page. A control may contain other controls and may be interactive with other controls or with user or audience inputs.

Thus, the template 510 may comprise one or more controls (e.g., the controls 514 and 518). Because controls are an abstraction of one or more operations, the controls 514 and 518 are shown as dashed-line boxes on FIG. 5. The control 514 is a “branding” control and contains logos 522 and 526. The control 518 is a navigation control and contains a header control 530 and pushbutton controls 534, 538, and 542.

A view may comprise a set of attributes associated with a perception of presentation elements on a presentation page (e.g., on the presentation page 500). The view may include a position of each presentation element on the presentation page relative to other presentation elements on the page. For example, the logos 522 and 526 appear at positions (X1,Y1) and (X2,Y2), respectively, as a result of view information. View attributes may be established for a template as a whole (e.g., for the template 510) and for individual controls (e.g., for the controls 514, 518, 530, 534, 538, and 542 associated with the template 510.

One or more data elements selected from a dataset may also be associated with a control. A data element is a perceivable manifestation of a control, and appears at a location and with an appearance specified by the view. Thus, for example, the logo 522 is the perceivable manifestation of a data element comprising a bitmap 550 associated with and contained by the branding control 514. Text 554 (“MAKE A SELECTION”) is a data element associated with and contained by the pushbutton header control 530.

Turning back to FIG. 4, the apparatus 400 may include page component access logic 414 coupled to the page generation module 410. The page component access logic 414 may access a template (e.g., the template 510), a view, and a dataset in response to a client request. The apparatus 400 may also include view and data storage areas 426 and 428 coupled to the page component access logic 414 to store the view and datasets, respectively. Some embodiments may include a data provider 432 coupled to the page component access logic 414. The data provider 432 may populate the data storage area 428 with information from an external data source 434.

The apparatus 400 may further include a template storage area 438 coupled to the page generation module 410 to store the template. A controls storage area 442 may be operatively coupled to the page generation module 410 to store the controls. The apparatus 400 may also include a site map table 446 accessible by the page component access logic 414. The site map table 446 may associate the template, the view, and the dataset with a selected Web site.

The apparatus 400 may also include a rendering library 450 operatively coupled to the page generation module 410. The rendering library 450 may store one or more sets of PRPVs for interpretation at a client processing device. A set of PRPVs 454 may be associated with a set of presentation characteristics of a sensory output device (SOD) used to present a multimedia presentation at a client location, as described further below. The SOD may comprise a video monitor, an electronic device with a built-in video display, a television set, a holographic display device, a tactile device, an audio device, an olfactory device, a taste sensation device, or a force feedback mechanism, among others.

A set of PRPVs may also be associated with a state of the SOD or with a state of a filter used to filter the multimedia presentation. The state of the SOD may include an on or off state, whether a selected sensory channel is currently enabled in a multi-sensory SOD, a current availability of a presentation characteristic selected from the set of presentation characteristics, or a current level setting associated with the presentation characteristic. The level setting may comprise an amplitude setting, a frequency setting, or a sensitivity setting, among others. The filter may comprise a digital filter, an analog filter, a windowing function, or any other function that selectively acts upon a portion of the multimedia presentation in a predetermined way.

A subset of the set of PRPVs (e.g., the subset of PRPVs 456) may be associated with a multimedia presentation element (e.g., the logo 106A of FIG. 1). In some embodiments, a division of the rendering library may be organized by SOD, with the set of PRPVs corresponding to a selected SOD. A subdivision of the rendering library may be organized by presentation element, with the subset of PRPVs (e.g., the subset of PRPVs 456) corresponding to a selected presentation element.

The set of PRPVs may be downloaded to the client processing device to adapt the multimedia presentation to a presentation environment at the client location. The client processing device may use the set of PRPVs to render the presentation element for presentation at a SOD with a predetermined set of perceptual characteristics compatible with one or more presentation characteristics associated with the SOD.

SOD presentation characteristics may include a device type, an aspect ratio associated with a video display device, a resolution associated with the video display device, a color space parameter associated with the video display device, whether the video display device is limited to a set of NTSC-specified colors, a three-dimensional rendering format associated with the video display device, a multi-channel format associated with an audio device, whether an audio channel is enabled in the audio device, a tactile sensation format associated with a tactile output device, an olfactory sensation format associated with an olfactory stimulation device, a taste sensation format associated with a taste sensation stimulation device, or a force sensation format associated with a force feedback apparatus. Other presentation characteristics may be associated with other SOD types.

Predetermined perceptual characteristics may include a color, a size, a shape, a tactile pattern, an audio filter characteristic, a smell, a taste, a position relative to a presentation frame, a position relative to another presentation element, a presence or absence of a presentation element, or a behavior associated with a presentation element.

Behaviors associated with a presentation element may include a change or a rate of change from a first color to a second color, a first size to a second size, a first shape to a second shape, a first tactile pattern to a second tactile pattern, a first audio filter characteristic to a second audio filter characteristic, a first smell to a second smell, a first taste to a second taste, a first position relative to the presentation frame to a second position relative to the presentation frame, a first position relative to another presentation element to a second position relative to the other presentation element, or a first presence or absence of an element to a second presence or absence of the element.

The apparatus 400 may include a Web hosting module 460 coupled to the page generation module 410. The Web hosting module 460 may download the presentation page to the client processing device. Client entry logic 462 may be coupled to the Web hosting module to receive the message 412 from the client processing device and to allow entry to the Web hosting module 460. Entry to the Web hosting module 460 may be conditioned on a set of client validity checks.

Hardware validity logic 466 may be communicatively coupled to the client entry logic 462. The hardware validity logic 466 may query the client processing device to test for compliance with a set of hardware criteria. Site entry may be denied if the client device fails to meet a predetermined set of hardware requirements. Browser validity logic 468 may also be coupled to the client entry logic 462. The browser validity logic 468 may query the client processing device to test for compliance with a predetermined set of client browser requirements.

The apparatus 400 may also include geographic validity logic 472 coupled to the client entry logic 462. Content providers may distribute multimedia content according to geographical schemas. The geographic validity logic 472 may confirm that the client processing device is located in a geographic area of the world eligible to receive protected content to which access is attempted. The apparatus 400 may further include proxy access validity logic 474 coupled to the client entry logic 462. The proxy access validity logic 474 may sense that multiple client processing devices sharing a single Internet protocol (IP) address are attempting system access. The proxy access validity logic 474 may establish programmable thresholds of numbers of client processing devices attempting access within a first programmable period of time. Access may be denied to the IP address for a second programmable period of time if one or more thresholds are exceeded.

The apparatus 400 may also include a site redirection engine 478 coupled to the client entry logic 462. The site redirection engine 478 may redirect the client to a selected Web site if the client is disallowed entry to the Web hosting module 460.

In another embodiment, a system 480 may include one or more of the apparatus 400, including a page generation module 410 and a rendering library 450. The system 480 may also include page design logic 484. The page design logic 484 may accept input 486 from a Web designer and may assemble a multi-rendered multimedia presentation with elements as previously described. The page design logic 484 may also generate one or more sets of PRPVs to be downloaded to a client processing device. The set of PRPVs may be used to interpret the presentation at the client processing device as previously described. The system 480 may also include one or more local SODs 488 coupled to the page design logic 484. The local SODs 488 and the page design logic 484 may be used to model a desired predetermined set of perceptual characteristics.

Any of the components previously described may be implemented in a number of ways, including embodiments in software. Software embodiments may be used in a simulation system, and the output of such a system may provide operational parameters to be used by the various apparatus described herein.

Thus, the presentation pages 100, 300, 500; the logos 106A, 106B, 106C, 522, 526; the viewport 110; the text block 114; the header element 118; the pushbuttons 124A, 124B, 124C; the monitor 200; the bands 210A, 210B; the distances 310A, 310B, 314; the elongation 318; the apparatus 400; the page generation module 410; the message 412; the template 510; the controls 514, 518, 530, 534, 538, 542; the bitmap 550; the text 554; the page component access logic 414; the storage areas 426, 428, 438, 442; the data provider 432; the external data source 434; the site map table 446; the rendering library 450; the set of PRPVs 454; the subset of PRPVs 456; the web hosting module 460; the client entry logic 462; the hardware validity logic 466; the browser validity logic 468; the geographic validity logic 472; the proxy access validity logic 474; the site redirection engine 478; the system 480; the page design logic 484; the web designer input 486; and the locals SODs 488 may all be characterized as “modules” herein.

The modules may include hardware circuitry, optical components, single or multi-processor circuits, memory circuits, software program modules and objects, firmware, and combinations thereof, as desired by the architect of the apparatus 400 and the system 480 and as appropriate for particular implementations of various embodiments.

The apparatus and systems of various example embodiments may be useful in applications other than generating, assembling, and serving a multimedia presentation that is adaptable to capabilities and states of output devices and presentation software on-the-fly as the presentation is presented at a client processing device. Thus, various embodiments of the invention are not to be so limited. The illustrations of the apparatus 400 and of the system 480 are intended to provide a general understanding of the structure of various embodiments. They are not intended to serve as a complete or otherwise limiting description of all the elements and features of apparatus and systems that might make use of the structures described herein.

The novel apparatus and systems of various embodiments may comprise and/or be included in electronic circuitry used in computers, communication and signal processing circuitry, single-processor or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., Motion Picture Experts Group, Audio Layer 3 (MP3) players), vehicles, medical devices (e.g., heart monitor, blood pressure monitor, etc.), set top boxes, and others. Some embodiments may include a number of methods.

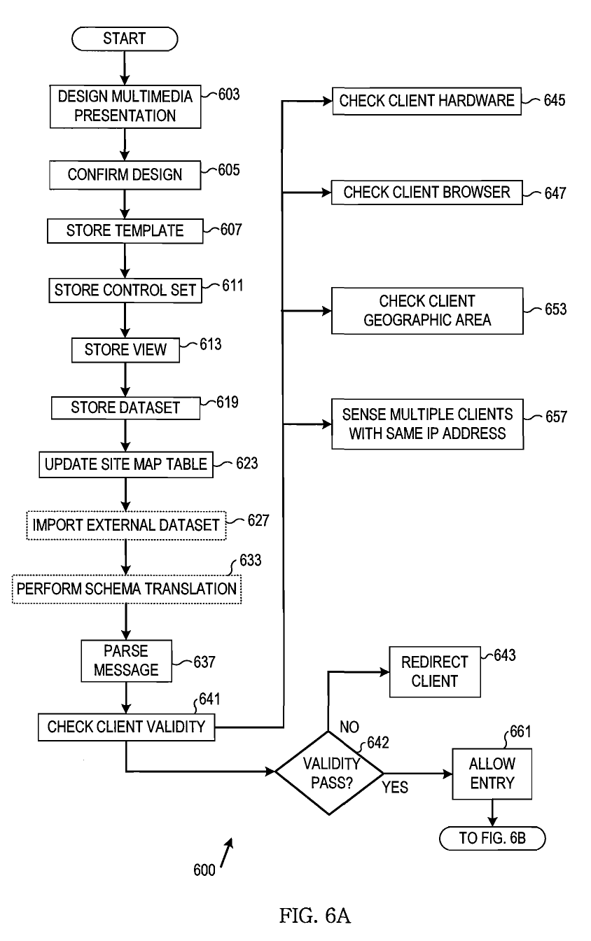

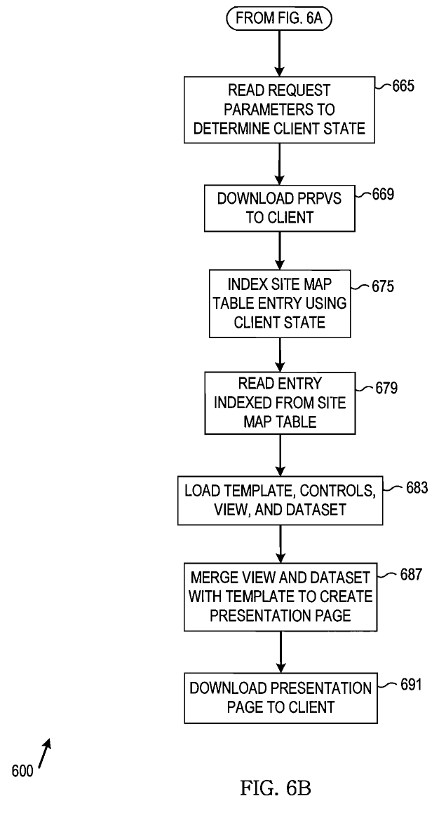

FIGS. 6A and 6B are flow diagrams illustrating several methods according to various example embodiments of the invention. A method 600 may operate at a multi-rendered presentation server to assemble a multimedia presentation. A presentation page may be assembled from a template of controls, a view, and a dataset, and may include one or more presentation elements. A set of PRPVs may act upon the presentation elements at a client processing device to render the elements. An element may be rendered for presentation at a SOD with a predetermined set of perceptual characteristics compatible with one or more presentation characteristic associated with the SOD. Embodiments herein may thus render the presentation page with characteristics appropriate to a selected output device.

The method 600 may commence at block 603 with designing the multimedia presentation, including the template of controls, the view, the dataset, and the set of PRPVs. The method 600 may also include confirming the design using one or more local SODs, at block 605.

The method 600 may continue at block 607 with storing a template in a template storage area. The method 600 may include storing a set of controls, a view, and a dataset in a controls storage area, a view storage area, and a data storage area, at blocks 611, 613, and 619 respectively. The method 600 may also include updating a site map table with location entries for the template, the set of controls, the view, and the dataset, at block 623.

The method 600 may optionally include importing an external dataset into the data storage area, at block 627. In some embodiments, the method 600 may include performing a schema translation on the external data set to standardize variable names, at block 633. Some embodiments may use extensible Markup Language (XML) in the schema translation.

The method 600 may continue at block 637 with parsing a message received from the client processing device. The message may be parsed to determine a client domain and a client request. The message may comprise a URL in some embodiments, as previously mentioned. The method 600 may include performing a set of client validity checks, at block 641. The method 600 may include determining whether a requester has passed the set of client validity checks, at block 642. A client failing the set of validity checks may be denied entry to a Web hosting module (e.g., the Web hosting module 460 of FIG. 4) and may be re-directed to a selected Website, at block 643.

The set of client validity checks may include testing for compliance with a set of client processing device hardware criteria, at block 645. The validity check may also include testing for compliance with a set of client browser requirements, at block 647. The validity check may further include confirming that the client processing device is located in a geographic area of the world eligible to receive protected content to which access is attempted, at block 653. The validity check may also sense whether multiple client processing devices sharing a single IP address are attempting system access, at block 657. The latter event may indicate that a group of users with separate client processing devices is attempting to bypass content access restrictions. The method 600 may also include allowing entry to the Web hosting module if the requester passes the set of client validity checks, at block 661.

The method 600 may continue at block 665 with reading a set of request parameters associated with the client request to determine a state of the client processing device. The set of request parameters may include a common gateway interface (CGI) parameter and one or more hypertext transport protocol (HTTP) cookies associated with the client processing device. The client device state may include an identifier of a requested presentation page and whether the client is authorized to view content that includes the requested page. Other state parameters are possible.

The method 600 may also include downloading one or more sets of presentation rendering property values (PRPVs) to a client processing device, at block 669. Each set of PRPVs may be associated with a set of presentation characteristics of a SOD used to present a multimedia presentation, a state of the SOD, or a state of a filter used to filter the multimedia presentation. A subset of PRPVs may be associated with a multimedia presentation element.

The method 600 may further include indexing an entry from a site map table using the state of the client processing device, at block 675. The entry in the site map may include addresses of presentation page components, and may be read at block 679. The method 600 may also include loading the template including the set of controls, the view, and the dataset according to the entry in the site map table, at block 683. The method 600 may further include merging the view and the dataset with the template of controls to create the multimedia presentation page, at block 687. The method 600 may conclude with downloading the presentation page or a cached version of the page to the client processing device, at block 691. In some embodiments, the presentation page may be assembled from the template, the controls, the view, and the dataset and may be downloaded while the client request is pending. That is, the page generation operation may occur in real time rather than as a batch operation.

It may be possible to execute the activities described herein in an order other than the order described. Various activities described with respect to the methods identified herein may be executed in repetitive, serial, or parallel fashion, or a combination thereof.

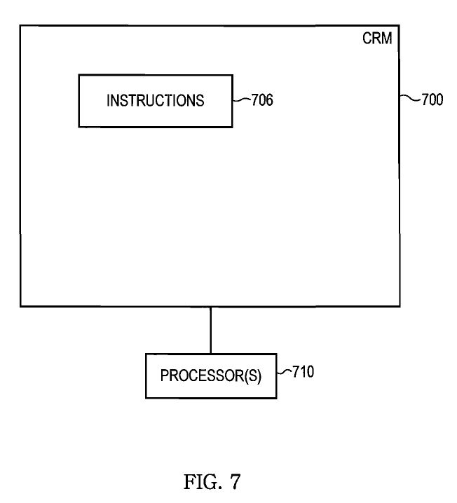

A software program may be launched from a computer-readable medium (CRM) in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment. Thus, other embodiments may be realized, as discussed regarding FIG. 7 below.

FIG. 7 is a block diagram of a computer-readable medium (CRM) 700 according to various embodiments. Examples of such embodiments may comprise a memory system, a magnetic or optical disk, or other storage device. The CRM 700 may contain instructions 706 which, when accessed, result in one or more processors 710 performing any of the activities previously described, including those discussed with respect to the method 600 noted above.

The apparatus, systems, and methods disclosed herein may enable higher levels of abstraction at the production and delivery stages of multimedia content generation by assembling content pages from reusable elements and by adapting a multimedia presentation to capabilities and states of output devices and presentation software on-the-fly as the presentation is experienced by an audience. Cost efficiencies may be realized thereby.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims and the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. § 1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, comprising:
a rendering library to store at least one set of presentation rendering property values (PRPVs) for interpretation at a client processing device, the set of PRPVs being associated with at least one of a set of presentation characteristics of a sensory output device (SOD) used to present a multimedia presentation, a state of the SOD, or a state of a filter used to filter the multimedia presentation, and a subset of the set of PRPVs being associated with a multimedia presentation element; and
a page generation module operatively coupled to the rendering library to parse a message received from the client processing device for a client domain and a client request, to download the set of PRPVs to the client processing device, and to assemble a template, a view, and a dataset to generate a presentation page in response to the client request.

2. The apparatus of claim 1, wherein the message comprises a uniform resource locator (URL).

3. The apparatus of claim 1, incorporated into a multimedia content server.

4. The apparatus of claim 1, wherein the SOD comprises at least one of a video monitor, an electronic device with a built-in video display, a television set, a holographic display device, a tactile device, an audio device, an olfactory device, a taste sensation device, or a force feedback apparatus.

5. The apparatus of claim 1, wherein the filter comprises at least one of a digital filter, an audio filter, or a windowing module.

6. The apparatus of claim 1, wherein the rendering library is configured to store the sets of PRPVs for downloading to the client processing device to enable the client processing device to render the presentation element using the subset of PRPVs such that the presentation element is presented at the SOD with a predetermined set of perceptual characteristics compatible with at least one presentation characteristic associated with the SOD.

7. The apparatus of claim 6, wherein the at least one presentation characteristic associated with the SOD comprises at least one of a device type, an aspect ratio associated with a video display device, a resolution associated with the video display device, a color space parameter associated with the video display device, whether the video display device is limited to a set of NTSC-specified colors, a three-dimensional rendering format associated with the video display device, a multi-channel format associated with an audio device, whether an audio channel is enabled in the audio device, a tactile sensation format associated with a tactile output device, an olfactory sensation format associated with an olfactory stimulation device, a taste sensation format associated with a taste sensation stimulation device, or a force sensation format associated with a force feedback device.

8. The apparatus of claim 6, wherein the predetermined perceptual characteristic comprises at least one of a color, a size, a shape, a tactile pattern, an audio filter characteristic, a smell, a taste, a position relative to a presentation frame, a position relative to at least one other presentation element, a presence or absence of the element, or a behavior associated with the element.

9. The apparatus of claim 8, wherein the behavior associated with the element comprises a change from at least one of a first color to a second color, a first size to a second size, a first shape to a second shape, a first tactile pattern to a second tactile pattern, a first audio filter characteristic to a second audio filter characteristic, a first smell to a second smell, a first taste to a second taste, a first position relative to the presentation frame to a second position relative to the presentation frame, a first position relative to the at least one other presentation element to a second position relative to the at least one other presentation element, or a first presence or absence of the element to a second presence or absence of the element.

10. The apparatus of claim 8, wherein the behavior associated with the element comprises a rate of change from at least one of a first color to a second color, a first size to a second size, a first shape to a second shape, a first tactile pattern to a second tactile pattern, a first audio filter characteristic to a second audio filter characteristic, a first smell to a second smell, a first taste to a second taste, a first position relative to the presentation frame to a second position relative to the presentation frame, a first position relative to the at least one other presentation element to a second position relative to the at least one other presentation element, or a first presence or absence of the element to a second presence or absence of the element.

11. The apparatus of claim 1, further including:
a division of the rendering library corresponding to the plurality of sets of PRPVs, the division organized by SOD; and
a sub-division of the rendering library corresponding to the subset of PRPVs, the sub-division organized by presentation element.

12. The apparatus of claim 1, further including:
page component access logic coupled to the page generation module to access the template, the view, and the dataset in response to the client request.

13. The apparatus of claim 12, wherein the template comprises a set of controls, a control containment attribute, or an interaction between two or more controls.

14. The apparatus of claim 12, wherein a control comprises an operation associated with the presentation page, the operation to be performed during a time of presenting the presentation page.

15. The apparatus of claim 12, wherein the view comprises a set of attributes associated with at least one of a perception of each presentation element or a position of each presentation element on the presentation page relative to other presentation elements on the presentation page.

16. The apparatus of claim 12, wherein the dataset comprises a set of data elements, each data element a perceivable manifestation of a control at a location specified by the view and manifested as specified by the view.

17. The apparatus of claim 12, further including:
a site map table accessible by the page component access logic, the site map table to associate the template, the view, and the dataset with a Web site.

18. The apparatus of claim 12, further including:
a template storage area coupled to the page generation module to store the template;
a controls storage area operatively coupled to the page generation module to store the at least one control;
a view storage area coupled to the page component access logic to store the view; and
a data storage area coupled to the page component access logic to store the dataset.

19. The apparatus of claim 12, further including:
a data provider coupled to the page component access logic to populate a data storage area with information from an external data source.

20. The apparatus of claim 1, wherein the state of the SOD comprises at least one of an on or off state, whether a selected sensory channel is currently enabled in a multi-sensory SOD, a current availability of a presentation characteristic selected from the set of presentation characteristics, or a current level setting associated with the presentation characteristic.

21. The apparatus of claim 20, wherein the level setting comprises at least one of an amplitude setting, a frequency setting, or a sensitivity setting.

22. The apparatus of claim 1, wherein the presentation element comprises at least one of a logo, a header, a block of text, an action pushbutton, a radio button, a slider, text-fillable fields, a text entry control, a drag-and-drop control, a bitmapped image, or a video viewport.

23. The apparatus of claim 1, wherein the presentation element is located within a specified zone of a page of the multimedia presentation.

24. The apparatus of claim 1, wherein the presentation element is located on a specified page of the multimedia presentation.

25. The apparatus of claim 1, further including:
a Web hosting module coupled to the page generation module to download the presentation page to the client processing device.

26. The apparatus of claim 25, further including:
client entry logic coupled to the Web hosting module to receive the message from the client processing device and to allow entry to the Web hosting module conditioned on a set of client validity checks.

27. The apparatus of claim 26, further including:
hardware validity logic coupled to the client entry logic to query the client processing device to test for compliance with a set of client processing device hardware criteria.

28. The apparatus of claim 26, further including:
browser validity logic coupled to the client entry logic to query the client processing device to test for compliance with a set of client browser requirements.

29. The apparatus of claim 26, further including:
geographic validity logic coupled to the client entry logic to confirm that the client processing device is located in a geographic area of the world eligible to receive protected content to which access is attempted.

30. The apparatus of claim 26, further including:
proxy access validity logic coupled to the client entry logic to sense that multiple client processing devices sharing a single Internet protocol (IP) address are attempting system access.

31. The apparatus of claim 26, further including:
a site redirection engine coupled to the client entry logic to redirect the client processing device to a selected Web site if the client processing device is disallowed entry to the Web hosting module.

32. A system, including:
page design logic to accept designer input and to assemble a multi-rendered multimedia presentation including a plurality of sets of presentation rendering property values (PRPVs) for interpretation at a client processing device, a set of PRPVs being associated with at least one of a set of presentation characteristics of a remote sensory output device (SOD) used to present a multimedia presentation, a state of the remote SOD, or a state of a filter used to filter the multimedia presentation, and a subset of the set of PRPVs being associated with a presentation element of the multimedia presentation;
a rendering library to store the plurality of sets of PRPVs for downloading to the client processing device to enable the client processing device to render the presentation element using the subset of PRPVs such that the presentation element is presented at the remote SOD with a predetermined set of perceptual characteristics compatible with at least one presentation characteristic associated with the remote SOD; and
a page generation module operatively coupled to the rendering library to parse a message received from the client processing device for a client domain and a client request, to download the plurality of sets of PRPVs to the client processing device, and to assemble a template, a view, and a dataset to generate a presentation page in response to the client request.

33. The system of claim 32, further including:
at least one local SOD to model the predetermined set of perceptual characteristics using the page design logic.

34. A method, including:
downloading at least one set of presentation rendering property values (PRPVs) to a client processing device, each set of PRPVs being associated with at least one of a set of presentation characteristics of a sensory output device (SOD) used to present a multimedia presentation, a state of the SOD, or a state of a filter used to filter the multimedia presentation, and a subset of the set of PRPVs being associated with a multimedia presentation element; and
at a multi-rendered presentation server, assembling a page of the multimedia presentation containing the presentation element from a template, a set of controls, a view, and a dataset such that the set of PRPVs, acting upon the presentation element at the client processing device, is capable of rendering the presentation element for presentation at the SOD with a predetermined set of perceptual characteristics compatible with at least one presentation characteristic associated with the SOD.

35. The method of claim 34, further including:
parsing a message received from the client processing device for a client domain and a client request; and
downloading at least one of the page of the multimedia presentation or a cached version of the page of the multimedia presentation to the client processing device.

36. The method of claim 35, further including:
allowing entry to a Web hosting module conditioned on a set of client validity checks.

37. The method of claim 36, wherein the set of client validity checks comprises at least one of:
testing for compliance with a set of client processing device hardware criteria;
testing for compliance with a set of client browser requirements;
confirming that the client processing device is located in a geographic area of the world eligible to receive protected content to which access is attempted; and
sensing that multiple client processing devices sharing a single Internet protocol (IP) address are attempting system access.

38. The method of claim 36, further including:
redirecting the client processing device to a selected Web site if the client processing device is disallowed entry to the Web hosting module.

39. The method of claim 34, further including:
reading a set of request parameters associated with a client request to determine a state of the client processing device; and
indexing an entry from a site map table using the state of the client processing device.

40. The method of claim 39, wherein the set of request parameters comprises at least one of a common gateway interface (CGI) parameter or at least one hypertext transport protocol (HTTP) cookie associated with the client processing device.

41. The method of claim 39, further including:
reading the entry in the site map table;
loading the template, the set of controls, the view, and the dataset according to the entry in the site map table; and
merging the view and the dataset with a template of controls to create the page of the multimedia presentation.

42. The method of claim 34, further including:
storing a template in a template storage area;
storing a set of controls in a controls storage area;
storing at least one view in a view storage area;
storing a dataset in a data storage area; and.
updating a site map table with location entries for the template, the set of controls, the at least one view, and the dataset.

43. The method of claim 42, further including:
importing an external dataset into the data storage area.

44. The method of claim 43, further including:
performing a schema translation on the external data set to standardize variable names.

45. The method of claim 44, wherein the schema translation comprises an extensible markup language (XML) schema translation.

46. A computer-readable medium having instructions, wherein the instructions, when executed, result in at least one processor performing:
downloading at least one set of presentation rendering property values (PRPVs) to a client processing device, the set of PRPVs being associated with at least one of a set of presentation characteristics of a sensory output device (SOD) used to present a multimedia presentation, a state of the SOD, or a state of a filter used to filter the multimedia presentation, and a subset of the set of PRPVs being associated with a multimedia presentation element; and
at a multi-rendered presentation server, assembling a page of the multimedia presentation containing the presentation element from a template of controls, a view, and a dataset such that the set of PRPVs, acting upon the presentation element at the client processing device, is capable of rendering the presentation element for presentation at the SOD with a predetermined set of perceptual characteristics compatible with at least one presentation characteristic associated with the SOD.

47. The computer-readable medium of claim 46, wherein the instructions, when executed, result in the at least one processor performing:
configuring the multi-rendered presentation server to download the set of PRPVs in response to a client request.

48. The computer-readable medium of claim 46, wherein the instructions, when executed, result in the at least one processor performing:
designing the multimedia presentation, including the template of controls, the view, the dataset, and the set of PRPVs; and
confirming the design using at least one local SOD.
